(19) United States
(12) Patent Application Publication
(10) Pub. No.: US 2025/0074391 A1
(43) Pub. Date: Mar. 6, 2025

(54) ROAD LOAD BASED HYBRID ELECTRIC VEHICLE CHARGE SUSTAINING BATTERY STATE OF CHARGE TARGET SETTING

(71) Applicant: FCA US LLC, Auburn Hills, MI (US)

(72) Inventor: Benjamin Dean, Rochester Hills, MI (US)

(21) Appl. No.: 18/459,493

(22) Filed: Sep. 1, 2023

(51) Int. Cl. B60W 20/13; B60W 10/06; B60W 10/08; B60W 20/12

(52) U.S. Cl. CPC B60W 20/13; B60W 10/06; B60W 10/08; B60W 20/12; B60W 2300/12; B60W 2510/244; B60W 2530/10; B60W 2552/05; B60W 2552/15; B60W 2555/20; B60W 2555/40; B60W 2555/60; B60W 2710/06; B60W 2710/083; B60W 2710/244

(57) ABSTRACT

An intelligent battery charge depletion system for an electrified powertrain of a range-extended electrified vehicle (REEV) determines a modified state of charge (SOC) setpoint based on an estimated road load and an estimated gross combined vehicle weight (GCCW) of the REEV. The modified SOC setpoint is different than a charge sustaining SOC setpoint and is for a battery system having an SOC and that is configured to power an electric motor of the electrified powertrain. The estimated road load is for a road segment that the REEV is traversing. The system also controls the electric motor based on the modified SOC setpoint and the battery system SOC to maintain a torque reserve that the electric motor and the battery system can use when needed; and controls an engine of the electrified powertrain to selectively recharge the battery system.

### FIELD

The present application generally relates to range-extended electrified vehicles (REEVs) and, more particularly, to road load based charge sustaining battery state of charge (SOC) target setting for REEVs.

### BACKGROUND

Range is discussed as one of the major issues in preventing certain consumers from considering/purchasing electrified vehicles (EVs). Range-extended EVs (REEVs) aim to achieve extended range, but the consumer preconceptions still exist. Overcoming this preconception is particularly important, for example, for an REEV configured pickup truck with towing capability. Conventional REEVs deplete their battery charge first to minimize instantaneous fuel consumption, followed by maintaining a target level of battery state of charge (SOC). This control strategy is also known as “charge depletion, charge sustaining.” For long-distance and towing scenarios, this is noticeable to the driver (i.e., a quickly depleting EV range value), including the subsequent shift to using the engine for power/recharging, which will be audibly noticeable and tend to operate at a higher speed than a conventional vehicle giving the perception of reduced capability. Accordingly, while such conventional REEVs do work for their intended purpose, there exists an opportunity for improvement in the relevant art.

### SUMMARY

According to one example aspect of the invention, an intelligent battery charge depletion system for an electrified powertrain of a range-extended electrified vehicle (REEV) is presented. In one exemplary implementation, the intelligent battery depletion system comprises a set of devices configured to monitor a set of parameters indicative of at least (i) a state of charge (SOC) of a battery system connected to an electric motor of the electrified powertrain, (ii) an estimated road load of a road segment that the REEV is traversing, and (iii) an estimated gross combined vehicle weight (GCVW) of the REEV and a controller configured to determine a modified SOC setpoint based on the estimated road load and the estimated GCVW of the REEV, wherein the modified SOC setpoint is different than a charge sustaining SOC setpoint, control the electric motor based on the modified SOC setpoint and the battery system SOC to maintain a torque reserve that the electric motor and the battery system can use when needed, and control an engine of the electrified powertrain to selectively recharge the battery system.

In some implementations, the controller is configured to determine the modified SOC setpoint using a predetermined lookup table relating GCVW of the REEV to modified SOC setpoints for the battery system. In some implementations, the controller is configured to estimate the road load based on altitude, ambient temperature, and one or more road parameters. In some implementations, the one or more road parameters include at least one of road grade and road type or speed limit. In some implementations, the controller is configured to estimate the road load based further on at least one of a driver selection of a tow/haul mode, a driver selection of a long trip mode, and a trailer hookup via monitoring of a trailer plug.

In some implementations, the controller is further configured to perform blended charge depletion (BCD) by determining a modified charge depletion rate at which the SOC of the battery system is depleted to power the electric motor, wherein the modified charge depletion rate is less than a maximum discharge rate, and controlling the electric motor based on the modified charge depletion rate until the SOC of the battery system reaches the modified SOC setpoint. In some implementations, the controller is further configured to determine a set of navigation parameters associated with a navigation system of the set of devices, and control the electric motor based further on the set of navigation parameters. In some implementations, the charge sustaining setpoint is a predetermined value for the REEV with no associated payload, and wherein the modified SOC setpoint is one of a plurality of values that are each different than the charge sustaining setpoint. In some implementations, the REEV is a pickup truck configured to tow a payload.

According to another example aspect of the invention, an intelligent battery charge depletion method for an electrified powertrain of an REEV is presented. In one exemplary implementation, the method comprises providing a set of devices configured to monitor a set of parameters indicative of at least (i) a state of charge (SOC) of a battery system connected to an electric motor of the electrified powertrain, (ii) an estimated road load of a road segment that the REEV is traversing, and (iii) an estimated GCVW of the REEV, determining, by a controller, a modified SOC setpoint based on the estimated road load and the estimated GCVW of the REEV, wherein the modified SOC setpoint is different than a charge sustaining SOC setpoint, controlling, by the controller, the electric motor based on the modified SOC setpoint and the battery system SOC to maintain a torque reserve that the electric motor and the battery system can use when needed, and controlling, by the controller, an engine of the electrified powertrain to selectively recharge the battery system.

In some implementations, determining the modified SOC setpoint comprises using a predetermined lookup table relating GCVW of the REEV to modified SOC setpoints for the battery system. In some implementations, the method further comprises estimating, by the controller, the road load based on altitude, ambient temperature, and one or more road parameters. In some implementations, the one or more road parameters include at least one of road grade and road type or speed limit. In some implementations, the method further comprises estimating, by the controller, the road load based further on at least one of a driver selection of a tow/haul mode, a driver selection of a long trip mode, and a trailer hookup via monitoring of a trailer plug.

In some implementations, the method further comprises performing, by the controller, blended charge depletion (BCD) by determining a modified charge depletion rate at which the SOC of the battery system is depleted to power the electric motor, wherein the modified charge depletion rate is less than a maximum discharge rate, and controlling the electric motor based on the modified charge depletion rate until the SOC of the battery system reaches the modified SOC setpoint. In some implementations, the method further comprises determining, by the controller, a set of navigation parameters associated with a navigation system of the set of devices, and controlling, by the controller, the electric motor based further on the set of navigation parameters. In some implementations, the charge sustaining setpoint is a predetermined value for the REEV with no associated payload, and wherein the modified SOC setpoint is one of a plurality of values that are each different than the charge sustaining setpoint In some implementations, the REEV is a pickup truck configured to tow a payload.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a range-extended electrified vehicle (REEV) having an intelligent battery charge depletion system according to the principles of the present application;

FIG. 2 is a flow diagram of an example intelligent battery charge depletion method for a battery system of an electrified powertrain of an REEV according to the principles of the present application; and

FIGS. 3A-3B are example plots of a conventional charge sustaining control, a blended charge depletion (BCD), and the intelligent battery charge depletion technique according to the principles of the present application.

### DESCRIPTION

As previously discussed, conventional range-extended electrified vehicles (REEVs) typically operate in a “charge depletion, charge sustaining” (CDCS) mode where battery charge is depleted first to minimize instantaneous fuel consumption, followed by maintaining a target level of battery state of charge (SOC). For long-distance and towing scenarios, this is noticeable to the driver (i.e., a quickly depleting EV range value), including the subsequent shift to using the engine for power/recharging, which will be audibly noticeable and tend to operate at a higher speed than a conventional vehicle giving the perception of reduced capability. This could be particularly true and problematic for REEVs where the charge sustaining setpoint is associated with no additional loads (e.g., carried loads and/or trailer payloads).

One potential solution to this problem is referred to herein as a smart “blended charge depletion” (BCD) mode that accounts for a variety of factors in determining how battery charge is depleted during a vehicle trip. During the BCD mode, both the engine and the battery system are utilized to slowly deplete the battery system SOC over an extended vehicle trip. This is achieved through subjective cost calibrations and noise/vibration/harshness (NVH) limits. A metric called vehicle demand energy (VDE) could be calculated based on parameters such as rolling resistance, aerodynamic drag, road grade, and trailer payload/mass. The selection or enablement of a tow mode by the driver can also be taken into account. In one embodiment, the BCD mode reaches the target battery SOC (e.g., ˜23%) at the end of the trip (e.g., distance-based, such as via a driver input). In another embodiment, the BCD mode utilizes navigation information (speed limits, road grades, traffic conditions, etc.) for more intelligent planning of the charge depletion to the target battery SOC.

Another potential solution to this problem is referred to herein as a “Mountain Mode” that increases a charge sustaining SOC setpoint to a single increased (e.g., maximum) level when enabled. More specifically, when enabled (e.g., in response to a selection by a driver), the Mountain Mode increases the charge sustaining setpoint to a very high (e.g., maximum) level in order to preserve electrical energy for anticipated hilly terrain. Each of the above-described solutions has respective drawbacks. The Mountain Mode and its single change sustaining SOC setpoint, for example, has two downfalls. First, the all-electric range estimation in this mode is always reduced by a fixed amount. This may be a valid estimate, however, only for a conventional passenger vehicle that does not have large changes in VDE driven by other factors such as trailer towing and large payloads. In other words, there is a fixed setpoint and if the battery system SOC, when Mountain mode is selected, is less than the respective charge sustaining setpoint, the powertrain (e.g., an electric motor/generator) will have to charge the battery system up to that point.

For a vehicle (e.g., a pickup truck) with a large gross combined vehicle weight (GCVW), the single charge sustaining setpoint is defined for that vehicle at that GCVW, and the resulting amount of reserve may not always be needed for all drivers, which will force the electric motor/generator to run much more than is necessary. Additionally, that customer towing a lower amount than GCVW may not have enough time for the SOC to get to the charge sustaining setpoint before the high vehicle demand is reached. The BCD mode, on the other hand, starts in a charge depletion state where the initial SOC is much higher than the SOC needed. Once the battery system is depleted to the charge sustaining state the vehicle only has the capability of the electric motor/generator, with limited non-engine propulsion assistance. If a global charge sustaining set point is used for all vehicle road load conditions, a setpoint could be chosen that prioritizes longer all-electric driving range over battery power availability. This longer range setpoint, however, may not have the power available for all driving conditions if the engine is thermal or environmentally power limited.

Accordingly, improved control systems and methods for an electrified powertrain of an electrified vehicle and, more particularly, battery system SOC control systems and methods for REEVs are presented herein. These “intelligent battery charge depletion” techniques intelligently change the charge sustaining SOC setpoint as a function of estimated vehicle load in anticipation of high road load conditions. The estimated vehicle load could be, for example, a gross combined vehicle weight (GCVW) including the REEV, any carried cargo (passengers, items in a trunk or truck bed, etc.) as well as a trailer payload, if applicable. The road load is estimated based on various parameters such as altitude, ambient temperature, road parameters (grade, road type, speed limit, etc.) and the like. This solution is more optimized and more efficient than the other solutions and could also be utilized in conjunction with other techniques, such as BCD, with or without leveraging navigation information (see below).

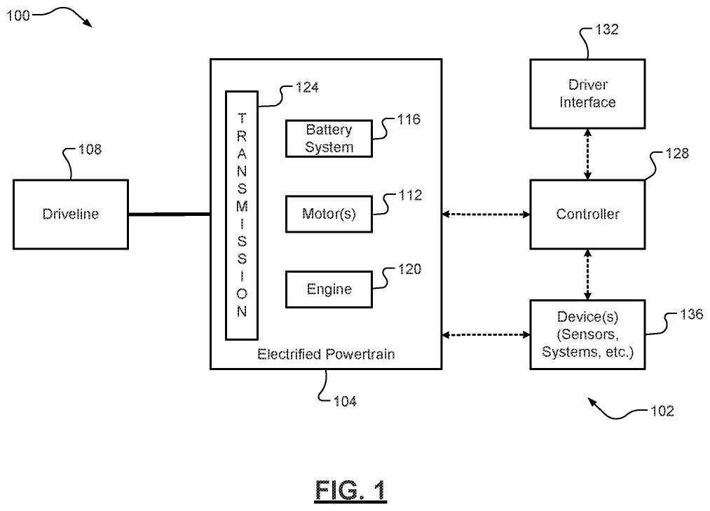

Referring now to FIG. 1, a functional block diagram of an example REEV 100 having an intelligent battery charge depletion or allocation system 102 according to the principles of the present application is illustrated. While a REEV-configured electrified vehicle is specifically shown and described herein, it will be appreciated that the techniques of the present disclosure. In one exemplary implementation, the REEV 100 is a pickup truck configured to tow a payload. The REEV 100 (also referred to herein as “vehicle 100”) generally comprises an electrified powertrain 104 configured to generate and transfer drive torque to a driveline 108 for vehicle propulsion. The powertrain 104 comprises one or more electric motors 112 powered by a battery system 116 and configured to generate the drive torque (torque generator) and/or generate electrical energy (torque consumer) to recharge the battery system 116. While a battery system is specifically shown and described herein, it will be appreciated that the techniques of the present application could be applicable to other energy storage systems, such as fuel cell systems (e.g., hydrogen, or “H2” fuel cell systems) and the like.

The powertrain 104 also comprises an internal combustion engine 120 configured to combust a mixture of fuel (gasoline, diesel, etc.) and air to generate torque. The torque collectively generated by the electric motor(s) 112 and the engine 120 is transferred to the driveline 108 via a transmission 124. In some implementations, the engine 120 is only configured to operate as a generator for recharging the battery system 116. A controller 128 controls operation of the REEV 100, including controlling the powertrain 104 to generate a desired amount of drive torque based on a driver torque request received via a driver interface 132 (e.g., an accelerator pedal). The controller 128 also receives inputs from a set of devices 136 (sensors, other systems, etc.) that are used in performing powertrain torque control. Non-limiting examples of the devices 136 include vehicle/engine speed sensors, a battery system SOC sensor, a navigation system (e.g., including a global navigation satellite system, or GNSS transceiver), a trailer payload/plug sensor, and vehicle mode sensor(s) (long trip, tow/haul, tow/haul+electric, etc.).

According to one aspect of the present application, the intelligent battery depletion system 102 utilizes the set of devices 136 to monitor a set of parameters indicative of at least (i) the SOC of the battery system 116, (ii) an estimated road load of a road segment that the REEV 100 is traversing, and (iii) an estimated GCVW of the REEV 100. Some of these devices 136 could themselves be configured to determine/estimate these parameters and the controller 128 could be configured to determine/estimate these parameters, such as based on other monitored parameters from the set of devices 136. The controller 128 is configured to determine a modified SOC setpoint based on the estimated road load and the estimated GCVW of the REEV 100, where the modified SOC setpoint is different than a charge sustaining SOC setpoint (e.g., for an REEV with no additional load). The controller 128 is configured to then control the electric motor(s) 112 based on the modified SOC setpoint and the SOC of the battery system 116 to maintain a torque reserve that the electric motor(s) 112 and the battery system 116 may use. The controller 128 is also configured to control the engine 120 for selective recharging of the battery system 116.

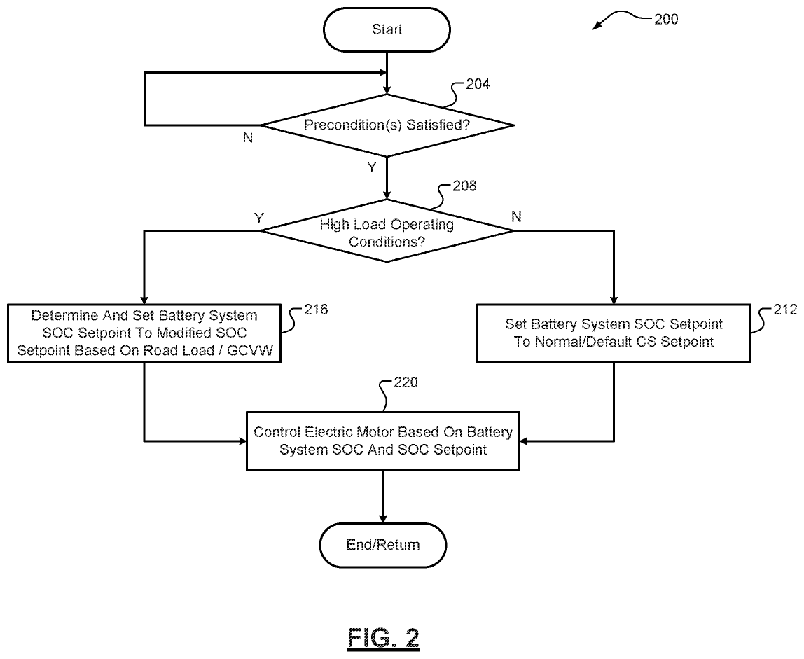

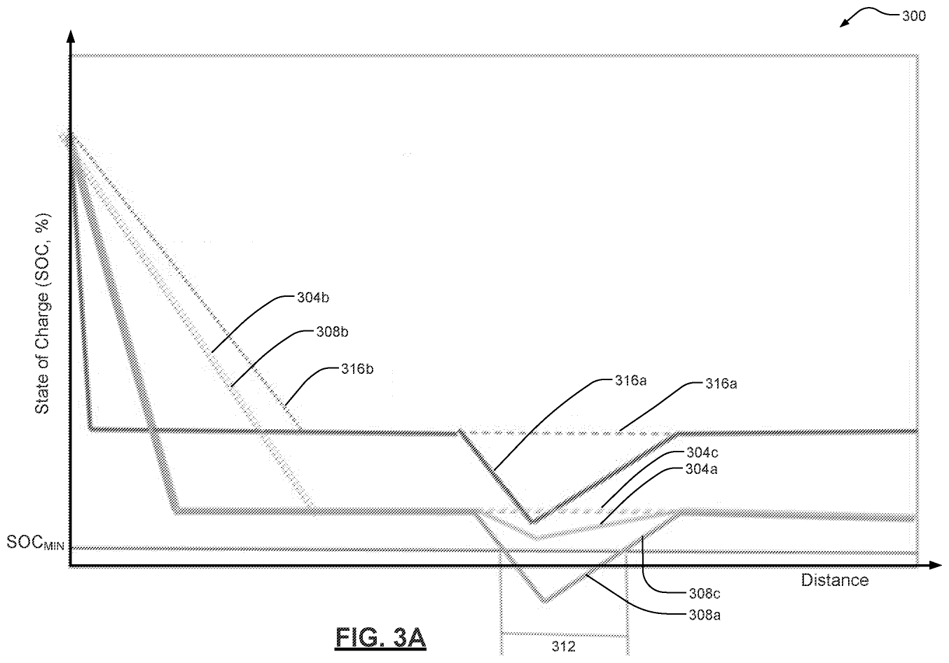

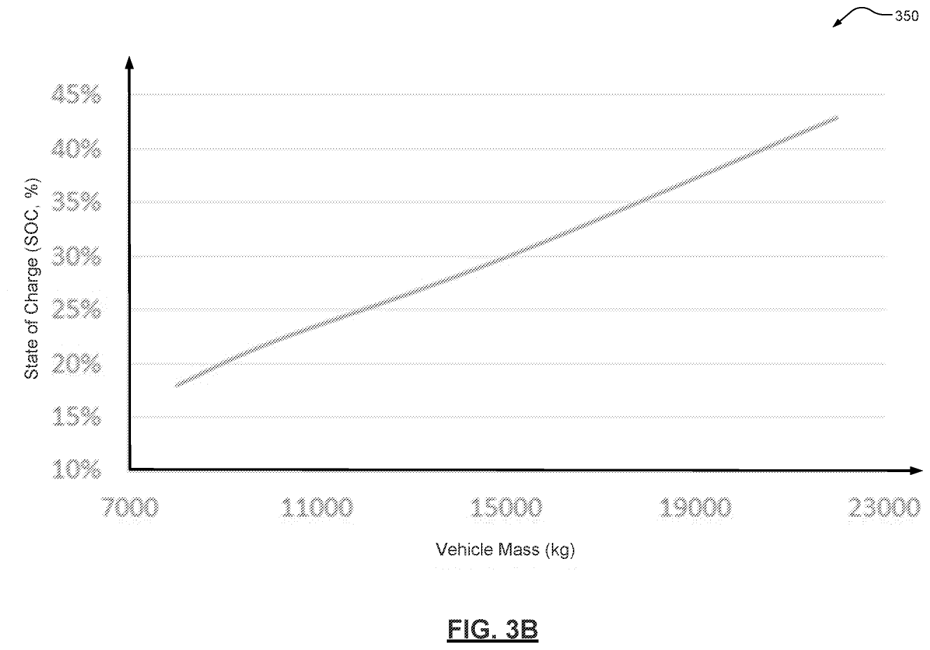

Referring now to FIGS. 2 and 3A-3B and with continued reference to FIG. 1, a flow diagram of an example intelligent battery charge depletion method 200 for an REEV and an example plot 300 of the conventional charge sustaining technique, the BCD technique, and the intelligent battery charge depletion technique according to the principles of the present application are illustrated. While the REEV 200 and its components are specifically referenced for illustrative purposes, it will be appreciated that the method 200 could be applicable to any suitable electrified vehicle having both an engine and one or more electric motors powered by a battery system. At 204, the controller 128 determines whether a set of preconditions are satisfied. This could include, for example, both the engine 120 and electric motor(s) 112 being in working order, the battery system 116 having a threshold SOC, and an absence of any faults or malfunctions. When true, the method 200 proceeds to 208. Otherwise, the method 200 ends or returns to 504. It will be appreciated that step 504 is an optional step and that the method 200 could begin at 208. At 208, the controller 128 determines whether a high road load mode or conditions exist. This could be, for example, when the estimated road load and the related parameters indicate a high load scenario (e.g., trailering a large payload up a steep grade). When false, the controller 128 sets the SOC setpoint for the battery system 116 to the normal or default CS setpoint at 212 and the method 200 proceeds to 216.

When true, however, the method 200 proceeds to 216. At 216, the controller 128 determines a modified SOC setpoint based on the estimated road load and GCVW, with the modified SOC setpoint being different than the normal/default CS setpoint. For example only, the controller 128 could use a predetermined lookup table relating GCVW of the REEV to modified SOC setpoints for the battery system 116 as shown in the plot of FIG. 3B. As previously discussed, the controller 128 could be configured to estimate the road load based on altitude, ambient temperature, and one or more road parameters (road grade, road type, speed limit, etc.), and possibly based further on at least one of a driver selection of a tow/haul mode, a driver selection of a long trip mode, and a trailer hookup via monitoring of a trailer plug. Some of these parameters could be additionally or alternatively utilized in determining whether or not the REEV is encountering the high load operating scenario at step 208 as discussed above. At 220, the controller 128 controls the electric motor(s) 112 based on the SOC setpoint (normal/default or modified) for the battery system 116 and its SOC. At optional 224 (not shown), the controller 128 could also control the engine 120 to selectively recharge the battery system 116 (e.g., periodically, when necessary). The method 200 then ends or returns to 204 for one or more additional cycles.

As previously discussed, in some implementations the controller 128 could be further configured to perform BCD by (i) determining a modified charge depletion rate at which the SOC of the battery system 116 is depleted to power the electric motor 112, wherein the modified charge depletion rate is less than a maximum discharge rate, and (ii) controlling the electric motor 112 based on the modified charge depletion rate until the SOC of the battery system 116 reaches the modified SOC setpoint. FIG. 3A shows an example plot 300 illustrating the performance differences between standard/normal road load conditions 304a (with optional BCD 304b and optional “Mountain Mode” CS setpoint increase 304c), high/extreme road load conditions 308a (with optional BCD 308b and optional “Mountain Mode” CS setpoint increase 308c), and lastly high/extreme road load conditions with the intelligent battery charge depletion techniques of the present application as shown by curve 316a (with optional BCD 316b. As shown, at high/extreme load conditions and without the techniques of the present application (and also without the “Mountain Mode” CS setpoint increase), the SOC of the battery system 116 drops below the minimum threshold (SOC_{MIN}), which is undesirable. Implementing the “Mountain Mode” (see 316c) in conjunction with the techniques of the present application does not make sense as it would prevent the additional torque from being accessible or generatable by the electrified powertrain 104.

BCD or navigation-based optimized SOC allocation in addition to determining and utilizing the modified SOC setpoint as described herein is now discussed in greater detail. For example, based on at least the battery system SOC and the trip distance, the controller 128 could be configured to determine a BCD profile or a navigation-based optimized SOC allocation profile (hereinafter, “navigation-based SOC allocation”) for powering the electric motor(s) 112 by the battery system 116 in conjunction with operating the engine 120. The controller 128 could be configured to then control the electrified powertrain 104 based on the BCD profile or navigation-based SOC allocation until the trip distance has been reached, after which the controller 128 could transition to a CS or similar mode where the engine 120 generates the drive torque and maintains the battery system SOC at a desired minimum level. Inputs provided by the navigation system 136 include, for example only, at least a destination for the trip, a route of travel to the trip destination, and road characteristics along the travel route. The road characteristics along the travel route include, for example only, at least some of road type (e.g., EV-only, or LEZ zones), road surface type (major paved road, rural paved road, unpaved road, etc.), road grade, road speed limits, weather conditions, and traffic conditions. The trailer payload being towed by the REEV 100 could also be considered.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An intelligent battery charge depletion system for an electrified powertrain of a range-extended electrified vehicle (REEV), the intelligent battery depletion system comprising:
a set of devices configured to monitor a set of parameters indicative of at least (i) a state of charge (SOC) of a battery system connected to an electric motor of the electrified powertrain, (ii) an estimated road load of a road segment that the REEV is traversing, and (iii) an estimated gross combined vehicle weight (GCVW) of the REEV; and
a controller configured to:
determine a modified SOC setpoint based on the estimated road load and the estimated GCVW of the REEV, wherein the modified SOC setpoint is different than a charge sustaining SOC setpoint;
control the electric motor based on the modified SOC setpoint and the battery system SOC to maintain a torque reserve that the electric motor and the battery system can use when needed; and
control an engine of the electrified powertrain to selectively recharge the battery system.

2. The intelligent battery charge depletion system of claim 1, wherein the controller is configured to determine the modified SOC setpoint using a predetermined lookup table relating GCVW of the REEV to modified SOC setpoints for the battery system.

3. The intelligent battery charge depletion system of claim 1, wherein the controller is configured to estimate the road load based on altitude, ambient temperature, and one or more road parameters.

4. The intelligent battery charge depletion system of claim 3, wherein the one or more road parameters include at least one of road grade and road type or speed limit.

5. The intelligent battery charge depletion system of claim 3, wherein the controller is configured to estimate the road load based further on at least one of a driver selection of a tow/haul mode, a driver selection of a long trip mode, and a trailer hookup via monitoring of a trailer plug.

6. The intelligent battery depletion charge depletion system of claim 1, wherein the controller is further configured to perform blended charge depletion (BCD) by:
determining a modified charge depletion rate at which the SOC of the battery system is depleted to power the electric motor, wherein the modified charge depletion rate is less than a maximum discharge rate; and
controlling the electric motor based on the modified charge depletion rate until the SOC of the battery system reaches the modified SOC setpoint.

7. The intelligent battery charge depletion system of claim 1, wherein the controller is further configured to:
determine a set of navigation parameters associated with a navigation system of the set of devices; and
control the electric motor based further on the set of navigation parameters.

8. The intelligent battery charge depletion system of claim 1, wherein the charge sustaining setpoint is a predetermined value for the REEV with no associated payload, and wherein the modified SOC setpoint is one of a plurality of values that are each different than the charge sustaining setpoint.

9. The intelligent battery charge depletion system of claim 1, wherein the REEV is a pickup truck configured to tow a payload.

10. An intelligent battery charge depletion method for an electrified powertrain of a range-extended electrified vehicle (REEV), the method comprising:
providing a set of devices configured to monitor a set of parameters indicative of at least (i) a state of charge (SOC) of a battery system connected to an electric motor of the electrified powertrain, (ii) an estimated road load of a road segment that the REEV is traversing, and (iii) an estimated gross combined vehicle weight (GCVW) of the REEV;
determining, by a controller, a modified SOC setpoint based on the estimated road load and the estimated GCVW of the REEV, wherein the modified SOC setpoint is different than a charge sustaining SOC setpoint;
controlling, by the controller, the electric motor based on the modified SOC setpoint and the battery system SOC to maintain a torque reserve that the electric motor and the battery system can use when needed; and
controlling, by the controller, an engine of the electrified powertrain to selectively recharge the battery system.

11. The method of claim 10, wherein determining the modified SOC setpoint comprises using a predetermined lookup table relating GCVW of the REEV to modified SOC setpoints for the battery system.

12. The method of claim 10, further comprising estimating, by the controller, the road load based on altitude, ambient temperature, and one or more road parameters.

13. The method of claim 12, wherein the one or more road parameters include at least one of road grade and road type or speed limit.

14. The method of claim 12, further comprising estimating, by the controller, the road load based further on at least one of a driver selection of a tow/haul mode, a driver selection of a long trip mode, and a trailer hookup via monitoring of a trailer plug.

15. The method of claim 10, further comprising performing, by the controller, blended charge depletion (BCD) by:
determining a modified charge depletion rate at which the SOC of the battery system is depleted to power the electric motor, wherein the modified charge depletion rate is less than a maximum discharge rate; and
controlling the electric motor based on the modified charge depletion rate until the SOC of the battery system reaches the modified SOC setpoint.

16. The method of claim 10, further comprising:
determining, by the controller, a set of navigation parameters associated with a navigation system of the set of devices; and
controlling, by the controller, the electric motor based further on the set of navigation parameters.

17. The method of claim 10, wherein the charge sustaining setpoint is a predetermined value for the REEV with no associated payload, and wherein the modified SOC setpoint is one of a plurality of values that are each different than the charge sustaining setpoint.

18. The method of claim 10, wherein the REEV is a pickup truck configured to tow a payload.
